(19) United States
(12) Patent Application Publication
(10) Pub. No.: US 2021/0410057 A1
(43) Pub. Date: Dec. 30, 2021

(54) Service Discovery Extension in a 5G Mobile Communication Network

(71) Applicant: Telefonaktiebolaget LM Ericsson (publ), Stockholm (SE)

(72) Inventors: Afshin Abtin, Sollentuna (SE); Charles Hegarty, Bromma (SE); Jonas Falkenå, Huddinge (SE)

(21) Appl. No.: 17/051,552

(22) PCT Filed: May 22, 2018
(86) PCT No.: PCT/EP2018/063390

§ 371 Date: Oct. 29, 2020

(51) Int. Cl. H04W 48/18; H04W 48/02; H04W 28/08; H04W 60/00

(52) U.S. Cl. CPC H04W 48/18; H04W 60/00; H04W 28/0846; H04W 48/02

(57) ABSTRACT

It is disclosed a server node, a 5G mobile communication network and a method performed therein, providing information, to a network function (NF) service consumer, for supporting selection of an NF instance out of a group of NF instances providing a target NF service. By using a network repository function (NRF) discovery request/response procedure, and an NF cluster instance ID that relates NF instances providing a certain service where the NF instances are hosted by one and the same NF, the NRF 406 determines IP addresses with which the requested service can be accessed. By using the NF cluster instance, one or more IP addresses for accessing NF instances providing the requested service hosted by one and the same NF 402, 404 is provided to the NF service consumer 408. The latency sensitive services and where load balancing is required, the NF service instance value knowledge about specific NF hosting the requested service, as well as High availability (HA) support.

### TECHNICAL FIELD

This disclosure relates to service discovery within a fifth generation communication (5G) core network (5GC) and IP multimedia subsystem (IMS). In more particular, it may relate to 5GC service discovery extension for an optimized service selection & addressing policy model.

### BACKGROUND

A 5G system can be divided into three domains being 5G access network (5G-AN), 5G core network (5GC) and user equipment (UE). Elements of the 5GC are called the network functions (NFs).

FIG. 1 shows an example of a service-based architecture of a 5G system, comprising the following NFs: Network slice selection function (NSSF), Network exposure function (NEF), Network repository function (NRF), Policy control function (PCF), Unified data management (UDM), Authentication server function (AUSF), Access and mobility management function (AMF), Session management function (SMF) and User plane function (UPF), which all may be considered to be part of the 5GC. These network functions, residing in a control-plane, are boxed using a solid line in FIG. 1. In addition an Application function (AF), a data network (DN), a (Radio) Access network ((R)AN) and a User equipment (UE) are illustrated in the 5GS. Also, various reference points are presented, of which some are realized over a network bus.

The NRF is outlined in 3G Partnership Project (3GPP) Technical specification (TS) 23.501 v15.1.0. The NRF provides an NF discovery service.

The NRF discovery procedure may be regarded to be an inquiry mechanism made by NFs towards the NRF on services that are accessible in the network.

Within the NRF discovery procedure, the NRF typically receives an NF discovery request from an NF instance for specific service available in the network. Based on the received NRF discovery request the NRF determines information of discovered NF instances or service instances. The NRF then provides this information of discovered NF instances or service instances to the requesting NF instance in an NRF discovery response.

The NRF can also maintain a NF profile of available NF instances and NF services that are supported by the NF instances.

The NRF discovery may be regarded as an inquiry for NF service resources, available to the NRF.

When the NF instance need information about which NF instances support a certain target service, the requesting NF instance incorporates the name of said certain target service in the NRF discovery request. When receiving an NRF discovery response, being a response to said request, the NRF discovery response will comprise one or more addresses to NF instances, which support the target service. However, according to the current specification (TS 23.502 v15.1.0), the one or more addresses, can be IP-addresses spanning many different network functions (NFs). Currently, the consumers or clients may thus receive IP-address(es) for the requested target service, where the(se) IP-address(es) can span many NFs.

Currently, the consumer/client has no information about whether the service, as provided by the NF instances, is hosted by one and the same NF or by many NFs. For consumers/clients it is useful to know whether a requested service is hosted by a specific NF or is dispersed in the sense being hosted by many NFs. For latency sensitive consumers/clients or consumers/clients that require high availability, for instance telecommunication clients, it is important, already at a discovery procedure stage, to have information whether the requested service is hosted by a specific NF.

According to current specification (TS 23.502) the consumer/client has thus no such information at this stage.

Since IP multimedia subsystem (IMS) and certain Internet of things (IoT) consumers/clients typically are latency sensitive and require High availability (HA), these consumers/clients need to have information about the NF service session; they need to be NF session state aware. This means that these consumers/clients need to know the address of NF instance providing the service and which particular NF that exposes the service.

For instance, in the event of an IMS or an IoT attach/register, an IMS consumer of a particular NF service provided by an NF instance, need to remain associated with NF instance, duration of registration, for the reason that re-registration attempts shall be sent to the same NF instance in the same NF.

In this respect the NF service consumer/client can be regarded to be “sticky” towards the NF service and the specific NF that exposes the service.

There is hence a need for a solution addressing one or more of the issues as discussed above.

### SUMMARY

It is an object of exemplary embodiments to address at least some of the issues outlined above, and this object and others are achieved by a 5G mobile communication system, a server node and methods performed therein, according to the appended independent claims, and by the exemplary embodiments according to the dependent claims.

According to an aspect, the exemplary embodiments provide a method performed in the 5G mobile communication network, the method providing information, to a network function service consumer, for supporting selection of a network function instance out of group of network function instances providing a target network function service. The method comprises sending from the network function service consumer, to a network repository function, a network repository function discovery request, wherein said discovery request comprises a name of the target network function service. The method also comprises determining, by the network repository function, a network repository function discovery response in response to the network repository function discovery request. The network repository function discovery response comprises one or more addresses for the target network function service, and one or more network function cluster instance identities. Each one of said one or more network function cluster instance identities relates two or more network function instances of the group of network function instances providing said target network function service, to at least one of said addresses, where said two or more network function instances, of the group of network function instances, are hosted by a specific network function. The specific network function is implemented as a virtualized network function. In addition, the method comprises sending from the network repository function, to the network function service consumer, the network repository function discovery response, for supporting said selection of a network function instance, out of the group of network function instances providing said target network function service, based on the determined network repository function discovery response, where the NF instance being selected is hosted by a specific network function.

According to another aspect, the exemplary embodiments provide a fifth generation mobile communication network being adapted to provide information, to a network function service consumer, for supporting selection of a network function instance out of a group of network function instances providing a target network function service. The fifth generation mobile communication system architecture comprises the network function service consumer, and a network repository function, wherein the network function service consumer is adapted to send, a network repository function discovery request to the network repository function, wherein the network repository function discovery request comprises a name of the target network function service, and wherein the network repository function is adapted to determine a network repository function discovery response in response to the network repository function discovery request, wherein the network repository function discovery response comprises one or more addresses for the target network function service, and one or more network function cluster instance identities, where each one of said one or more cluster instance identities relates two or more network function instances of the group of network function instances providing said target network function service, to at least one or said addresses, where said two or more network function instances, of the group of network function instances, are hosted by a specific network function that is implemented as a virtualized NF, VNF, and to send, to the network function service consumer, the network repository function discovery response, whereby the fifth generation mobile communication system is adapted to support selection of a network function instance, out of the group of network function instances providing said target network function service, based on the determined network repository function discovery response, where said network function instance to be selected is hosted by a specific network function.

According to another aspect, the exemplary embodiments provide a server node that is configured to support a fifth generation mobile communication system architecture to provide information, to a network function service consumer, for supporting selection of a network function instance out of a group of network function instances providing a target network function service. The fifth generation system architecture comprises the network function service consumer, and a network repository function. The server node comprises a processor and a memory storing a computer program comprising computer program code. When the computer program code is run in the processor, it causes the server node to send, from the network function service consumer, to a network function repository function, a network repository function discovery request, wherein the network repository function discovery request comprises a name of the target network function service. When the computer program code is run in the processor, it causes the server node to determine, by the network repository function, a network repository function discovery response in response to the network repository function discovery request, wherein the network repository function discovery response comprises one or more addresses for the target network function service, and one or more network function cluster instance identities, where each one of said one or more network function cluster instance identities relates two or more network function instances of the group of network function instances providing said target network function service, to at least one of said addresses, where said two or more network function instances, of the group of network function instances, are hosted by a specific network function that is implemented as a virtualized network function. In addition, when the computer program code is run in the processor, it causes the server node to send, from the network repository function, to the network function service consumer, the network repository function discovery response, for supporting said selection of a network function instance, out of the group of network function instances providing said target network function service, based on the determined network repository function discovery response, where the network function instance being selected is hosted by a specific network function.

### Advantages of Exemplary Embodiments as Disclosed Herein

It is an advantage that network function (NF) service consumers can implement more optimized service addressing functionality, as NF cluster instance ID comprises information about how load balancing can be performed per NF service request. Upon reception of a single IP address within the NF cluster instance ID, the NF service consumer is indicated that load balancing is catered for inside the NF that is exposing the requested service.

Latency critical NF service consumers/clients can dynamically select which NF instances shall provide the requested target NF service, and which NF shall host said target NF service. In the case of latency sensitive consumers/clients and/or when load balancing is required, it is imperative that the consumer remains associated with the NF throughout a session.

It is also an advantage that NF service consumers/clients having stringent High availability (HA) requirements can decide how their HA policy shall be enforced, e.g. the NF exposing the service address may have internal HA mechanism behind the exposed address. Alternatively, the NF service consumer/client may have to enforce HA mechanism based on a NF cluster instance identity and a range of IP addresses towards a specific NF.

The present disclosure also enables NFs that are offering state critical services to offer High availability (HA) functionality if so required, as the NRF can apply a selection criterion when determining IP addresses for said requested service.

### BRIEF DESCRIPTION OF THE DRAWINGS

Embodiments will now be described in more detail, and with reference to the accompanying drawings, in which:

FIG. 1 schematically presents a service-based architecture of a 5G mobile communication network;

FIGS. 2 and 3 schematically visualize NF service selection, according to some embodiments of the present disclosure;

FIGS. 4 to 6 illustrate hand-shake diagrams of a method performed in a 5G mobile communication network, according to some embodiments of the present disclosure;

FIG. 7 illustrates a flowchart of a method performed in a 5G mobile communication network, according to an embodiment; and

FIG. 8 schematically illustrates a server node, according to an embodiment of the present disclosure.

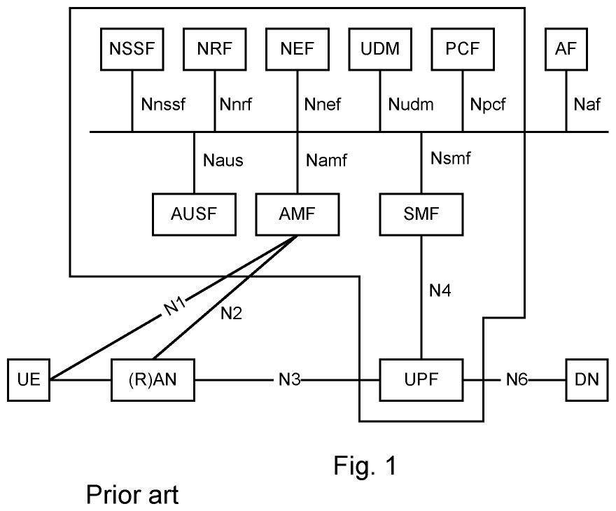

### DETAILED DESCRIPTION

In the following description, different embodiments of the exemplary embodiments will be described in more detail, with reference to accompanying drawings. For the purpose of explanation and not limitation, specific details are set forth, such as particular examples and techniques in order to provide a thorough understanding.

As was mentioned above, NF service consumers/clients have currently no information about whether a requested service, as provided by NF instances, is hosted by one and the same NF or by many NFs. For consumers/clients it is useful to know whether a requested service is hosted by a specific NF or is dispersed in the sense that it is hosted by many NFs. For latency sensitive consumers/clients or consumers/clients that require high availability, for instance telecommunication clients, it is important, already at a discovery procedure stage, to have information whether the requested service is hosted by a specific NF. It is thus a problem that consumers/clients currently have no such information.

It is herein proposed a solution with which consumers/clients are provided with information about whether a requested service, as provided by NF instances, is hosted by one and the same NF or by many NFs.

This information may be provided in the form of an NF instance cluster identity (ID) that is related with the service address or addresses received from the NRF. This NF instance cluster ID is provided as an output in a NRF discovery service operation. In the event of a range of IP addresses being returned in the NRF discovery service operation, the consumer/client becomes aware of which specific NF hosts which NF service.

This is an advantage, since the consumer/client of the NRF discovery service operation will have information about whether the requested service, as provided by NF instances, is hosted by one and the same NF or by many NFs. In the event that the consumer/client has information about that the service is hosted by one NF, the consumer/client can select an NF instance providing the requested service for latency sensitive services requiring high availability (HA).

It is important from an addressing and reliability optimization perspective for the consumer/client to know whether the exposed/returned NF service instance address from the NRF is part of a NF service cluster. If the returned NF service address represents a NF service cluster of the required service type, the returned NF service address can be used for purposes such as up-scaling and high availability issues.

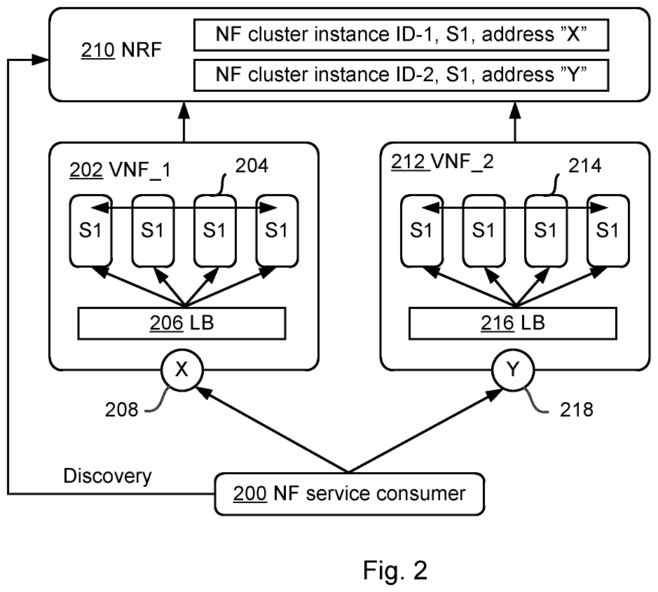

FIG. 2 schematically visualizes a part of a network architecture for service instance selection, according to some embodiments of the present disclosure. FIG. 2 comprises a network function (NF) service consumer 200, a first virtualized NF, VNF_1, 202, two or more NF instances 204 each providing a specific NF service S1, load balancing 206, an address 208 for accessing an NF instance cluster, a network repository function (NRF) 210, a second virtualized NF, VNF_2, 212, two or more NF instances 214 each providing a specific NF service S1, load balancing 216, and an address 218 for another NF instance cluster.

When the NF service consumer 200 requires an NF service, S1, the NF service consumer sends a NRF discovery request to the NRF 210. Within the NRF discovery request the NF instance consumer places the name of the NF service that is requested. By placing the name of the NF service in the NRF discovery request, the NF instance consumer requests addresses for the requested NF services from the NRF.

The present disclosure provides a solution to the problem that a NF instance requiring addresses for a NF service does not know whether the addresses for the service are addresses to NF instances hosted by a single NF or by a plurality of NFs.

In the case of latency sensitive services, for example in telecommunication networks, there is a need to select NF instances hosted by a single NF. NF instances hosted by a number of different NFs, will typically not be able to meet latency requirements and/or requirements for High availability (HA).

Based on the NRF discovery request, and the name of the NF service requested by the NF instance, the NRF determines information that is usable to the NF service consumer to select an NF instance belonging to a cluster of NF instances being hosted in the same NF.

This information may be in the form of an NF instance cluster identity (ID) that defines a cluster of NF instances providing the requested NF service S1. These NF instances are hosted by one and the same NF that is implemented by the virtualized NF, VNF_1, 202. The two or more NF instances 204 have the same address, address “X”. Within the cluster of NF instances, being addressable by the address, address “X”, load balancing (LB) 206 may be performed between the NF instances 204. The NF instances 204 may be regarded to be cloned and can balance each other's load within the cluster of NF instances. By selecting an NF instance that belongs to a cluster of NF instances, the NF service can provide the requested service while fulfilling latency requirements and/or requirements of high availability.

The NF service consumer 200 may alternatively use another NF cluster instance 214 hosted on one and the same NF, which NF is implemented by the virtualized NF, VNF_2, 212. By using this cluster information as provided by the NRF, the NF service consumer is provided with information about which NF instances 214 provide the requested NF service S1, where the NF instances are hosted on the same NF. The NF cluster instance 2 here relates NF instances providing the required NF service S1, where the NF instances have an address, address “Y”. The NF service consumer can here select an NF instance that belongs to a cluster of NF instances 214. Within the cluster of NF instances 214, here being addressable by the address, address “Y” 218, load balancing (LB) 216 may also be performed.

In the same way as above, by selecting an NF instance that belongs to a cluster of NF instances, the NF service can provide the requested service while fulfilling latency requirements and/or requirements of high availability.

From an addressing and reliability enhancement perspective, it is important for the consumer/client to know whether an exposed or returned NF instance address from the NRF belongs to a NF service cluster. In the case the NF instance address as received in the NRF discovery response represents a cluster of the required service type, this NF instance address can be used for up-scaling purposes and for solving availability issues.

It is noted that a prior-art consumer/client service discovery operation is outlined in a “Nnrf_NFDiscovery_Request”.

FIG. 2 hence visualizes a consumer/client service discovery procedure for service S1, which results in an IP address “X” and an IP address “Y” in addition to a respective NF cluster instance ID, being returned from the NRF, i.e. an identity of a NF cluster instance of NF instances being addressable with respective IP address.

By using the NF cluster instance ID information, the consumer/client is hereby provided with all requisite information in order to implement a deterministic policy functionality to make a service selection based on its requirements. In addition, the deterministic functionality can also decide how to address services based on its requirements. When the session state is of importance to the consumer/client, the consumer now becomes aware of that for service S1, it can consider IP address “X” and IP address “Y”. Based on NF cluster instance ID the consumer/client recognizes/understands that S1 is provided by an NF instance addressable using IP address “X” and which NF instance is hosted by a specific NF, and implemented as a virtualized NF, VNF_1. Likewise, the consumer/client also understands that S1 can be provided by an NF instance addressable using IP address “Y” and which NF instance is hosted by a specific NF, and implemented as a virtualized NF, VNF_2.

Thus, when the session state is of importance, the provided information enables the consumer/client to ensure that a certain NF service instance that provides the requested service, S1, is hosted on a particular NF for the duration of the lifecycle of the session. In this respect, the consumer/client may be regarded to be “sticky” towards the requested service, S1, on for example VNF_1, which is an implementation of the particular NF.

If the NF service supports IMS registrar, re-registration needs to be sent to either IP address “X” or IP address “Y” depending on which one was used for the initial registration for the consumer/client.

In session sensitive services it is imperative that re-registrations for the same session are processed in the same NF, as the initial registration, for latency reasons. Re-registering with an NF instance that is hosted on a NF, different from the NF used for initial registration, will typically not meet the IMS latency requirements.

The consumer/client being “sticky” is also relevant in other areas, such as for example, where the consumer needs to be sticky to the initially selected target for all transactions for the duration of the lifetime of the context e.g. UE-context in the case of access & mobility function (AMF) in 5GC.

Furthermore, in the case a consumer/client receives a NRF discovery response and the response comprises a NF cluster instance ID, the consumer/client recognizes that the requested service can be accessed by selecting an NF instance by addressing a specified NF that is hosting the NF instance. By receiving a NF cluster instance ID the consumer is certified that latency requirements can be fulfilled (within reasonable limits). For this reason the service addressing logic can be considered to be modified, upon introduction of NF cluster instance IDs

Hence, based on novel information that is provided by the NRF at service discovery procedure, the consumer/client is made aware of that the requested service, S1 is hosted by an NF instance that is part of a cluster of NF instances, and as such is dynamically highly available and scalable. The consumer/client can avail of inbuilt capabilities provided by service S1 and thus recognize that an efficient service addressing functionality can be utilized.

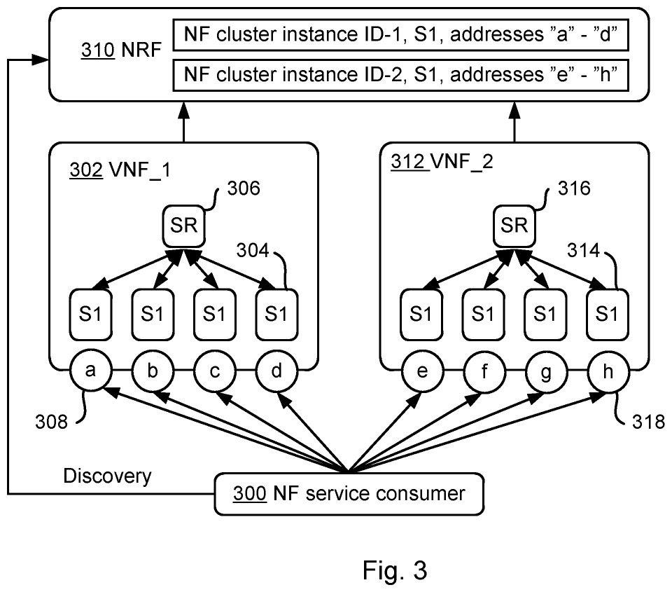

FIG. 3 schematically visualizes a part of a network architecture for service instance selection, according to some embodiments of the present disclosure. FIG. 3 has similarities with FIG. 2, but differs in certain aspects.

FIG. 3 comprises a network function (NF) service consumer 300, a first virtualized NF, VNF_1 302, two or more NF instances 304 each providing a specific NF service S1, session repository (SR), 306, addresses 308 for NF instances in the cluster, a network repository function (NRF) 310, a second virtualized NF, VNF_2 312, two or more NF instances 314 each providing a specific NF service S1, a session repository (SR), 316, and addresses 318 for accessing S1 in a certain NF that is realized by VNF_2, 312.

In the example shown in FIG. 3, a consumer/client service discovery procedure “Nnrf_NFDiscovery_Request” for service-1 (S1) results in IP addresses “a”, “b”, “c”, “d”, “e”, “f”, “g”, and “h” being provided from NRF in NRF discovery response. Additional information is however also provided in the form of a NF cluster instance ID-1 of NF instances addressable using IP-addresses “a”, “b”, “c”, and “d”, and a NF cluster instance ID-2 of NF instances addressable using IP-addresses “e”, “f”, “g”, and “h”.

In the same way as outlined for FIG. 2 above, the consumer/client in this example is provided with all the requisite information to implement a make a deterministic service selection and service addressing decision.

In a way similar to the one above, whenever the session state is of importance to the consumer/client, the consumer has now become aware of that for the requested service, S1, the consumer/client can consider IP addresses “a-d” and IP addresses “e-h”. Furthermore, the consumer/client may also recognize that that based on a NF cluster instance ID-1, IP addresses “a-d” 308 for the requested service S1 is hosted by a specific NF, being implemented by the VNF_1. In analogy, the consumer/client may also recognize that that based on an NF cluster instance ID-2, IP addresses “e-h” 318 for the requested service S1 is hosted by a specific NF, being implemented by the VNF_2.

In this particular case where session state is of importance the provided additional information from the NRF enables the consumer/client to ensure that the service S1 it chooses is hosted on a particular NF for a duration of a lifecycle of the session, i.e. the consumer/client is sticky towards service S1 on VNF_1, 302 or VNF_2, 312.

If the NF service supports IMS registrar, re-registration needs to be sent to either IP addresses “a-d” or IP addresses “e-h” depending on which one was used for the initial registration for the NF service consumer/client.

In session sensitive services it is imperative that re-registrations for the same session are processed in the same NF, as the initial registration, for latency reasons. Re-registering with an NF instance that is hosted on a NF that is different from the NF used for initial registration, will typically not meet the IMS latency requirements.

Furthermore, the provided information thus ensures that the consumer/client may decide on what type of service address logic needs to be used. Based on said additional information provided at service discovery the consumer/client is aware that service S1 is hosted by a NF that is implemented by VNF_1, 302 and is addressed by IP addresses “a-d”. Based on said additional information provided at service discovery the consumer/client is also aware that service S1 is hosted by a NF that is implemented by VNF_2, 312 and is addressed by IP addresses “e-h”.

However, the NF service consumer/client may recognize that whilst NF instances providing service S1 is part of a cluster and as such fulfills High availability, the consumer/client can has no possibility to avail of “built-in” load balancing functionality provided by the NF or VNF_1 in question. This in unlike the example as discussed in connection with FIG. 2.

Furthermore, scaling procedures on the NF may require adjustments handled by the consumer/client. The consumer/client may need to consider this when deciding on what service addressing functionality to use. Is there a cluster and are the NF instances addressed by a single IP address? Or are the NF instances addressed by several IP-addresses? In the case they are addressed by a single IP-address, load balancing may be performed with the NF/VNF. In the case they are addressed by several IP addresses, scaling may have to be catered by the consumer/client, instead.

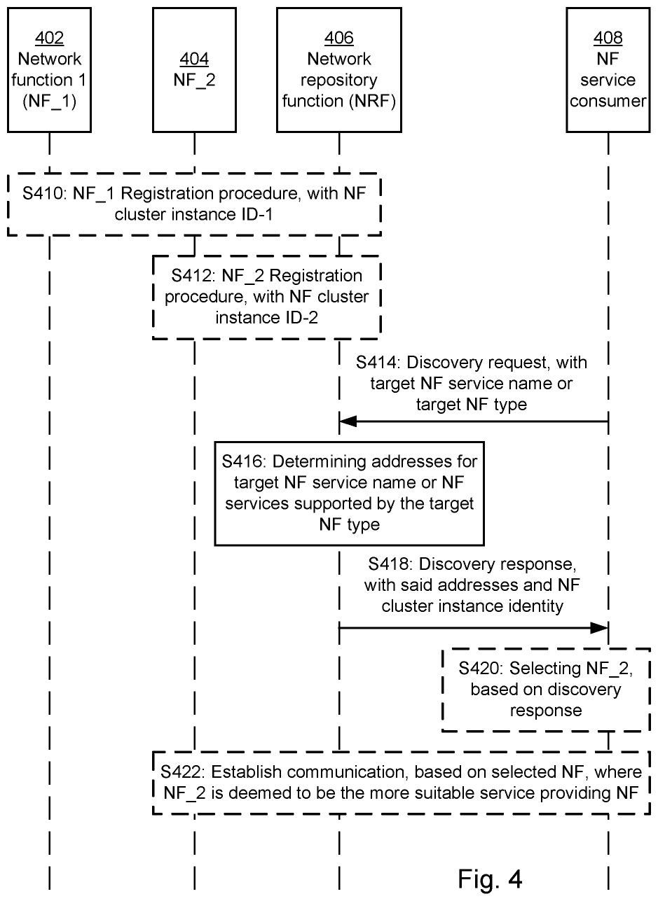

FIG. 4 illustrates a hand-shake diagram of a method performed in a 5G mobile communication network, according to some embodiments of the present disclosure. The handshake diagram involves a network function 1 (NF_1), 402, a NF_2, 404, a network repository function (NRF) 406, and an NF service consumer 408.

The hand-shake diagram comprises an example of a method involving an NRF discovery procedure.

Action S410: (optionally) The NF_1, 402 performs a registration procedure to NRF 406, with an NF cluster instance identity-1 (ID-1). A service producer (NF_1) may use a service operation “Nnrf_NFManagement_NFRegister service” to register its profile with the NRF. The profile of NF_1 may comprise information such as the type of the NF_1, and NF services that are supported by the NF_1. In addition, the service producing NF_1 also includes a NF cluster instance ID that provides extra information on functionality provided, for example, whether cluster functionality is provided, what type of cluster functionality is provided, in the case it is provided.

Action S412: (optionally) Similar to action S410, action S412 comprises NF_2 performing a registration procedure to NRF 406, with an NF cluster instance ID-2. A service producer (NF_2) uses the service operation “Nnrf_NFManagement_NFRegister service” to register its profile with the NRF 406. The profile of NF_2 may comprise information such as the type of NF_2, and which NF services that are supported by the NF_2. In addition, the service producing NF_2 also includes an NF cluster instance ID that provides extra information on functionality provided, for instance, whether cluster functionality is provided, and if so, what type of cluster functionality is being provided.

Action S414: The NF service customer 408 uses a service operation “Nnrf_NFDiscovery_Request” in order to discover one or more NF instances supporting a target NF service. Alternatively, the NRF discovery request may comprise a type of the target NF.

Action S416: The NRF 406 determines an NRF discovery response to the received NRF discovery request. The NRF discovery response comprises one or more addresses for the requested target NF service. In addition, the NRF also determines whether there are any NF cluster instance IDs that support this requested target NF service. If so, these NF cluster instance IDs relate NF service instances providing the requested NF service, while being hosted in one and the same NF. What type of cluster functionality is provided, may also be determined by the NRF, for instance, whether the requested service is addressed by a single IP address or by many IP addresses.

Action S418: The NRF now uses the service operation “Nnrf_NFDiscovery_Response”, being a response to the discovery request as sent by the NF service consumer 408. Now, the NRF discovery response comprises said one or more addresses for the requested target NF service, but in addition, the response may also comprise a NF cluster instance ID if present, which relates NF instances providing the requested NF service and a single particular NF, as implemented by a VNF, hosting the NF instances that provide the requested NF service. This additional information makes the NF service consumer aware of that the requested NF service can be accessed using these IP addresses, fulfilling latency requirements and requirements on High availability (HA).

Action S420: (optional) Having received the NRF discovery response, the NF service consumer 408 may now select a NF instance that is hosted by a particular NF. In this example, the NF service consumer selects the NF service as hosted in NF_2, 404. Selecting said NF service may be performed by addressing the NF_2, 404.

Action S422: (optional) A communication may now be established between the NF_2, 404 and the NF service consumer 408, based on the selection of the NF_2 in action S420. NF-2 is hereby deemed to be the more suitable service providing NF, out of NF_1 and NF_2.

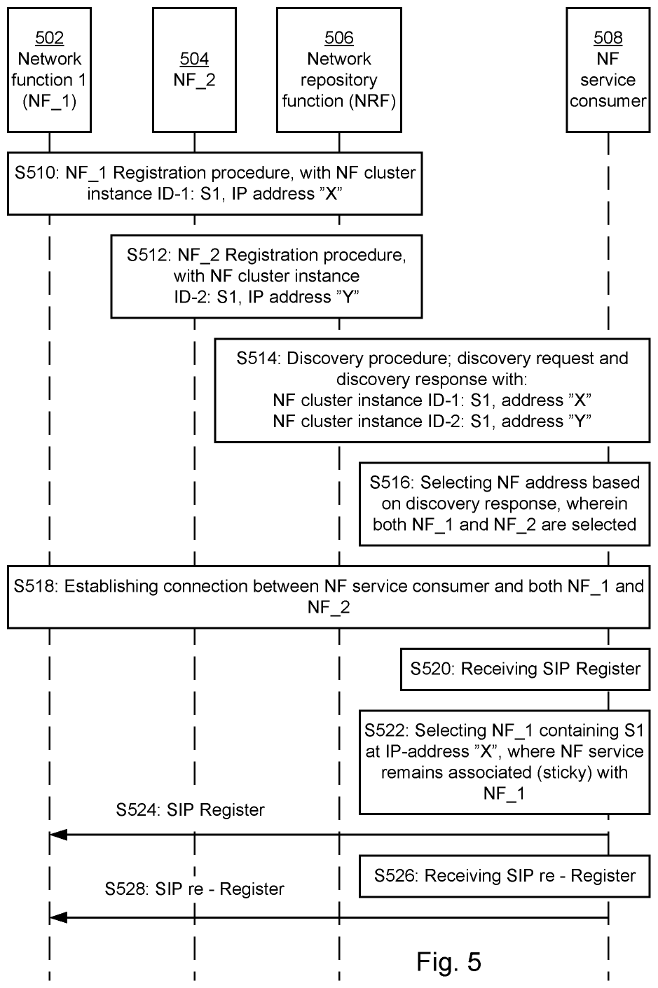

FIG. 5 illustrates a hand-shake diagram of a method performed in a 5G mobile communication network, according to some embodiments of the present disclosure. The handshake diagram involves a network function 1 (NF_1), 502, a NF_2, 504, a network repository function (NRF) 506, and an NF service consumer 508.

The handshake diagram comprises an example of a method involving an NRF discovery procedure.

Action S510: NF_1, 502 performs a registration procedure to NRF 506, with an NF cluster instance identity-1 (ID-1). A service producer (NF_1) uses the service operation “Nnrf_NFManagement_NFRegister service” to register its profile with the NRF. The profile of NF_1 may comprise information such as the type of the NF_1, and NF services that are supported by the NF_1. In addition, the service producing NF_1 also includes a NF cluster instance ID-1. This NF cluster instance ID-1 may be set to 1, to indicate that there is a cluster of NF service instances with ID-1 equal to 1, which NF instances provide the requested NF service, S1. The NF cluster instance also indicates that the requested NF service, i.e. the target NF service, is addressed by IP address “X”.

Action S512: Similar to action S510, action S512 comprises NF_2 performing a registration procedure to NRF 506, with an NF cluster instance ID-2. A service producer (NF_2) uses the service operation “Nnrf_NFManagement_NFRegister service” to register its profile with the NRF 506. The profile of NF_2 may comprise information such as the type of NF_2, and which NF services that are supported by the NF_2. In addition, the service producing NF_2 also includes an NF cluster instance ID-2. This NF cluster instance ID-2 may be set to 2, to indicate that there is a cluster of NF service instances with ID-2 equal to 2, which NF instances provide the requested NF service, S1. The NF cluster instance also indicates that the requested NF service, i.e. the target NF service, is addressed by IP address “Y”.

More information regarding addressing of NF services, see sections in connection with FIGS. 2 and 3.

Action S514: The NF service consumer/client 508 uses the service operation “Nnrf_NFDiscovery_Request” to discover one or more NF instances that provide the target NF service. Based on the request as sent to the NRF 506, the NRF determines a NR discovery response and sends this response to the NF service consumer 508. This NRF discovery response comprises one or more newly introduced NF cluster instance IDs, which indicate that NF service instances that provide the requested service, S1, are hosted by one and the same NF. In this example, the NRF discovery response comprises NF cluster instance ID-1 and NF cluster instance ID-2. Both these clusters are clusters of NF instances providing the requested NF service S1. The service S1 of NF cluster instance ID-1 is addressed by IP address “X”, whereas the service S1 of NF cluster instance ID-2 is addressed by IP address “Y”.

Action S516: Based on the service operation NRF discovery extension/extended information that is provided to the NF service consumer 508, the requested service may be selected using a deterministic service selection & addressing functionality herein introduced. In this example, the NF service consumer is latency critical and requires the requested service to be accessed from one and the same NF. Based on the received NRF discovery response and selection criteria for selecting services, the NF service instance 508 selects both NF_1 and NF_2, where both are offering the same requested service S1. From a service addressing criterion the NF service instance 508 is now aware of that NF_1 as well as NF_2 offers NF cluster instance functionality with High availability (HA) and load balancing (LB).

Action S518: Communication is now established between NF service consumer 508 and both NF_1, 502 and NF_2, 504.

Action S520: Furthermore, the NF service consumer 508 may now receive an IP multimedia subsystem (IMS) SIP register from a user, U1.

Action S522: As a result of the deterministic service selection & addressing functionality herein introduced, the NF service consumer 508 is now aware of that it can select the requested service S1, using SIP registrar functionality, either in NF_1, 502 or NF_2, 504 to serve the received SIP request. In the example, NF_1 is selected and this selection information is stored (for example, cashed) by the NF service consumer 508. For the duration of the session, all subsequent SIP transactions shall be served by service S1 in cluster ID-1 addressed at IP address “X”. The NF service consumer 508 shall thus herein remain associated with, worded differently “sticky” to, the NF_1, 502.

Action S524: The NF service consumer 508 sends a SIP register for user U1, towards the NF_1, 502 at IP address “X”.

Action S526: In this example, a SIP re-register for user U1 is received by the NF service consumer 508. Based on earlier data that may be cached, the NF service consumer 508 is aware of that the SIP transaction shall be sent to service S1 as hosted by NF_1, 502 at IP address “X”.

Action S528: The NF service consumer can hereby thus send a SIP re-register for user U1 to the correct NF, i.e. in this case NF_1, 502, which NF_1 contains earlier session state information related to this SIP transaction.

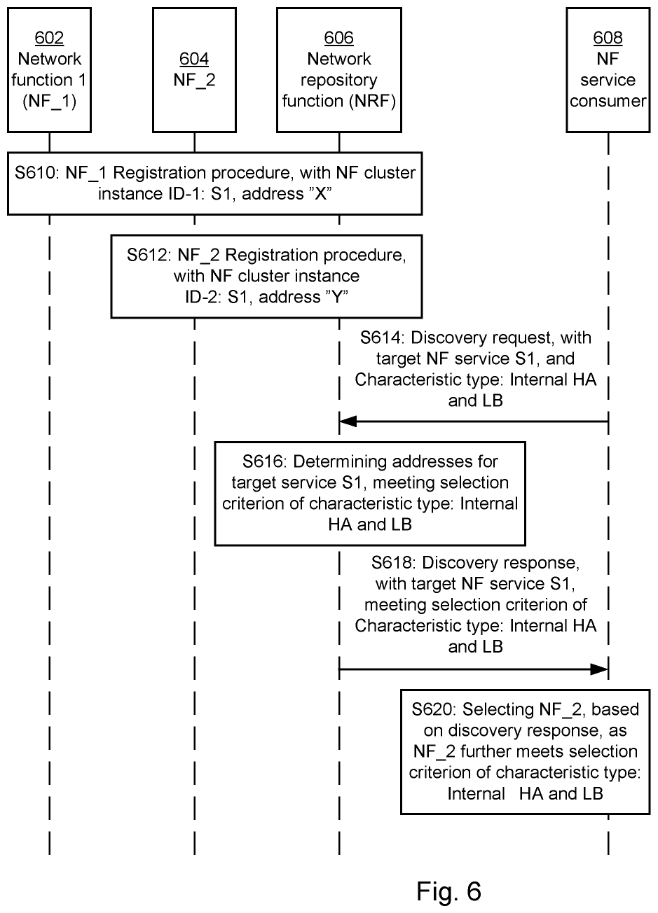

FIG. 6 illustrates a handshake diagram of a method performed in a 5G mobile communication network, according to some embodiments of the present disclosure. The handshake diagram involves a network function 1 (NF_1), 602, a NF_2, 604, a network repository function (NRF) 606, and an NF service consumer 608.

The handshake diagram comprises an example of a method involving an NRF discovery procedure.

The first two actions of FIG. 6, i.e. actions S610 and S612, are the same as actions S510 and S512, respectively, as presented in FIG. 5. For this reason Actions S610 and S612 are not described further, but reference is made to actions S510 and S512 instead.

Action S614: The NF service consumer 608 uses the service operation “Nnrf_NFDiscovery_Request” to discover one or more NF instances that provide the target NF service, S1. In addition, the NRF discovery request herein comprises a novel selection criterion of Characteristic type of NF in terms of High availability (HA) and load balancing (LB). By specifying a characteristic type of NF, the NF service consumer will be able to add the requirements of the requested service S1. In this example the NF service consumer may populate a “char-type” field with the required HA and LB support.

Action S616: The NRF 606 determines an NRF discovery response to the received NRF discovery request. The NRF discovery response comprises one or more addresses for the requested target NF service S1, where the NF instances providing the requested service S1 are hosted on one and the same NF. In addition, herein, the NRF also has to take into account the selection criterion of characteristic type in terms of HA and LB, as requested by the NF service consumer.

Action S618: The NRF 606 provides a NRF discovery response to the NF service consumer 608, comprising addresses to access the requested service S1, while meeting the selection criterion of characteristic type in terms of HA and LB.

For this NF service consumer it is here of importance that the requested service is hosted on a particular NF for the duration of a lifecycle of the session. The NF service consumer 608 has to remain associated, or “sticky”, towards the service S1 on for example NF_2. Also, from a service addressing perspective the NF service consumer requires the NF hosting the requested service S1 to support High availability (HA) and Load balancing (LB). For this reason the NRF discovery response from the NRF 606 comprises IP addresses to access the requested service S1, meeting the selection criterion of characteristic type in terms of HA and LB. These addresses will hence be comprised in NF cluster instance IDs, as received in the NRF discovery response.

Action S620: The NF service consumer 608 may now select NF_2, 604 based on the NRF discovery response, as NF_2, 604 meets the selection criterion of characteristic type in terms of HA and LB. Since only addresses to NFs meeting the selection criterion are provided in the NRF discovery response, from which addresses a selection is to be made by the NF service consumer, the deterministic service selection functionality may be considered to be optimized.

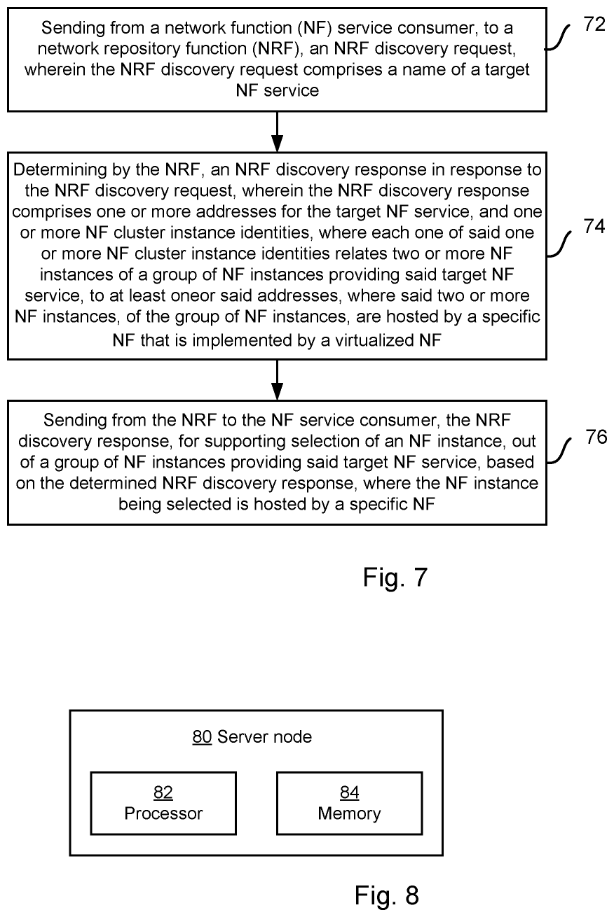

FIG. 7 illustrates a flowchart of a method performed in a 5G mobile communication network, according to an embodiment of the present disclosure. The method provides information, to a network function (NF) service consumer, for supporting selection of an NF instance out of group of NF instances providing a target NF service. The method comprises the following actions:

Action 72: Sending from the NF service consumer, to a network repository function (NRF), an NRF discovery request, wherein the NRF discovery request comprises a name of the target NF service.

Action 74: Determining, by the NRF, an NRF discovery response in response to the NRF discovery request. The NRF discovery response comprises one or more addresses for the target NF service, and one or more NF cluster instance identities. Each one of said one or more NF cluster instance identities relates two or more NF instances of the group of NF instances providing said target NF service, to at least one of said addresses, where said two or more NF instances, of the group of NF instances, are hosted by a specific NF. The specific NF is implemented as a virtualized NF (VNF).

Action 76: Sending from the NRF, to the NF service consumer, the NRF discovery response, for supporting said selection of an NF instance, out of the group of NF instances providing said target NF service, based on the determined NRF discovery response, where the NF instance being selected is hosted by a specific NF.

Each one of said one or more NF cluster instances may further comprise two or more of said NF instances providing said target NF service.

The method as illustrated in the flowchart may also comprise selecting (S420, S620) said NF instance out of the group of NF instances providing said target NF service, by the NF service consumer.

According to one embodiment, each one of said one or more NF cluster instance identities may have an individual address of said one or more addresses for the target NF service. Selecting said NF instance out of the group of NF instances may in this case comprise addressing two or more of said NF instances using a single address of said one or more addresses for the target NF service. The method may in this case also comprise load balancing being performed within each NF cluster instance between said two or more NF instances providing said target NF service.

According to another embodiment, each one of said two or more of said NF instances, within each NF cluster instance, may have an individual address of said one or more addresses for the target NF service. In such a case, selecting said NF instance out of the group of NF instances may comprise addressing two or more of said NF instances using individual addresses of said one or more addresses for the target NF service, where said two or more NF instances are hosted by a specific NF. Further, load balancing between said two or more of said NF instances, within each NF cluster instance, may in this case be performed by the NF service consumer.

Applicable to said one as well as said another embodiment, selecting S420, S620 said NF instance providing the target NF service, based on said one or more NF cluster instance identities, may comprise accessing the target NF service fulfilling one or more demands on latency and/or High availability (HA).

The method may also comprise sending S410, S412, S510, S512 from an NF that is hosting NF instances, to the NRF, an NRF registration message, wherein the NRF registration message comprises information about which NF service is being provided by said NF, and information relating said NF instances, and the NF service to an NF cluster instance identity.

Also, within the method the NRF discovery request may further comprise a specific characteristic type of a target NF type for NF services, and wherein the NRF discovery response comprises one or more addresses for NF services supported by the specific characteristic type of the target NF type. The specific characteristic type of said target NF type may comprise an NF type that supports High availability (HA) and/or load balancing (LB).

The present disclosure also comprises a computer program comprising instructions, when executed on at least one processor, cause the at least one processor to carry out the actions of the method as illustrated in the flowchart above.

The present disclosure also comprises a carrier containing the computer program, wherein the carrier may be one of an electronic signal, optical signal, radio signal, and a computer readable storage medium.

The present disclosure also comprises a fifth generation (5G) mobile communication system being adapted to provide information, to a network function (NF) service consumer 200, 300, 408, 508, 608, for supporting selection of an NF instance 204, 214, 304, 314 out of a group of NF instances providing a target NF service. The 5G mobile communication system architecture comprises the NF service consumer, and a network repository function (NRF) 210, 310, 406, 506, 606 wherein the NF service consumer is adapted to send, an NRF discovery request to the NRF, wherein the NRF discovery request comprises a name of the target NF service.

The NRF is adapted to determine an NRF discovery response in response to the NRF discovery request, wherein the NRF discovery response comprises one or more addresses for the target NF service, and one or more NF cluster instance identities, where each one of said one or more cluster instance identities relates two or more NF instances of the group of NF instances providing said target NF service, to at least one or said addresses, where said two or more NF instances, of the group of NF instances, are hosted by a specific NF. The specific NF is implemented as a virtualized NF (VNF).

The NRF is further adapted to send, to the NF service consumer, the NRF discovery response, whereby the 5G mobile communication system is adapted to support selection of an NF instance, out of the group of NF instances providing said target NF service, based on the determined NRF discovery response, where said NF instance to be selected is hosted by a specific NF 402, 404, 502, 504, 602, 604.

FIG. 8 schematically illustrates a server node 80, according to an embodiment of the present disclosure. The server node 80 is configured to support a 5G mobile communication system architecture to provide information, to a NF service consumer 200, 300, 408, 508, 608, for supporting selection of an NF instance 204, 214, 304, 314 out of a group of NF instances providing a target NF service, wherein the 5G system architecture comprises the NF service consumer, and a network repository function (NRF) 210, 310, 406, 506, 606. The server node comprises a processor 82 and a memory 84 that stores a computer program comprising computer program code which when run in the processor 82, causes the server node to:

Send, from the NF service consumer, to a network function repository function, NRF, an NRF discovery request, wherein the NRF discovery request comprises a name of the target NF service.

Determine, by the NRF, an NRF discovery response in response to the NRF discovery request. The NRF discovery response comprises one or more addresses for the target NF service, and one or more NF cluster instance identities. Each one of said one or more NF cluster instance identities relates two or more NF instances of the group of NF instances providing said target NF service, to at least one of said addresses, where said two or more NF instances, of the group of NF instances, are hosted by a specific NF. The specific NF is implemented as a virtualized NF (VNF).

Send, from the NRF, to the NF service consumer, the NRF discovery response.

The server node hereby supports said selection of an NF instance, out of the group of NF instances providing said target NF service, based on the determined NRF discovery response, where the NF instance being selected is hosted by a specific NF.

Each one of said one or more NF cluster instances may comprise two or more of said NF instances providing said target NF service.

The computer program comprising computer program code which when run in the processor 82 of the server node, may cause the NF service consumer to select said NF instance out of the group of NF instances providing said target NF service.

According to one embodiment of the server node 80, each one of said one or more NF cluster instance identities has an individual address of said one or more addresses for the target NF service. When the computer program code is run in the processor 82, it may cause the NF service consumer to address two or more of said NF instances using a single address of said one or more addresses for the target NF service. Also, when the computer program code is run in the processor 82, it may cause each NF cluster instance to perform load balancing between said two or more NF instances providing said target NF service.

According to another embodiment of the server node 80, each one of said two or more of said NF instances, within each NF cluster instance, has an individual address of said one or more addresses for the target NF service. Within said another embodiment, when the computer program code is run in the processor 82, it may cause the NF service consumer to address two or more of said NF instances using individual addresses of said one or more addresses for the target NF service, where said two or more NF instances are hosted by a specific NF. Also, when the computer program code is run in the processor 82, it may cause the NF service consumer to perform load balancing between said two or more of said NF instances, within each NF cluster instance.

Applicable to both embodiments of the server node, when the computer program code is run in the processor 82, it may cause the NF service consumer to access the target NF service fulfilling one or more demands on latency and/or high availability.

Also, when the computer program code is run in the processor 82 of the service node, it may cause an NF hosting NF instances to send, to the NRF, an NRF registration message, wherein the NRF registration message comprises information about which NF service is being provided by said NF, and information relating said NF instances, and the NF service to an NF cluster instance identity.

When the computer program code is run in the processor 82 of the service node, it may cause the NRF service consumer to send a NRF discovery request comprising a specific characteristic type of a target NF type for NF services, and wherein the NRF discovery response, being a response to said NRF discovery request, comprises one or more addresses for NF services supported by the specific characteristic type of the target NF type. The specific characteristic type of said target NF type may comprise an NF type that supports High availability (HA) and load balancing (LB).

The present application also discloses a service with which a trusted application function (AF) of a mobile communication network, may request a service from a network function (NF), which service meets requirements from the AF. For this purpose, a Network exposure function (NEF) uses a service operation for notifying exposure to the AF. An AF, as trusted by an operator, may subscribe for information at the NEF in a first subscription. Upon establishment of this first subscription of information, subscribed information may be exposed to the AF. The NEF may in turn subscribe for information at the network repository function (NRF) in a second subscription. Upon establishment this second subscription, the NRF may determine information based on the second subscription, and provide this information as a notification about status updates being sent from the NRF to the NEF. A status update may thus comprise one or more addresses for the target NF service, and one or more NF cluster instance identities.

The NEF in turn may then expose or transfer the information, i.e. one or more addresses for the target NF service, and one or more NF cluster instance identities, to the AF via the subscription/notification service that is established between the AF and the NEF. This service may be an over-the-top (OTT) service.

In this way, information that is determined in a NRF discovery procedure in accordance with teachings of the embodiments described throughout this disclosure, may be exposed to an AF, via the NEF. The AF may further be connected a user equipment (UE), which may hence then receive, at least parts of, said information.

It may be further noted that the above described embodiments are only given as examples and should not be limiting to the present exemplary embodiments, since other solutions, uses, objectives, and functions are apparent within the scope of the accompanying patent claims.

A reference to an element in the singular is not intended to mean “one and only one” unless explicitly so stated, but rather “one or more”. All structural and functional equivalents to the elements of the above-described embodiments that are known to those of ordinary skill in the art are expressly considered to be included herein and are intended to be encompassed hereby. Moreover, it is not necessary for a device or method to address each and every problem sought to be solved by the technology disclosed herein, for it to be encompassed hereby.

In the preceding description, for purposes of explanation and not limitation, specific details are set forth such as particular architectures, interfaces, techniques, etc. in order to provide a thorough understanding of the disclosed technology. However, it will be apparent to those skilled in the art that the disclosed technology may be practiced in other embodiments and/or combinations of embodiments that depart from these specific details. That is, those skilled in the art will be able to devise various arrangements which, although not explicitly described or shown herein, embody the principles of the disclosed technology. All statements herein reciting principles, aspects, and embodiments of the disclosed technology, as well as specific examples thereof, are intended to encompass both structural and functional equivalents thereof. Additionally, it is intended that such equivalents include both currently known equivalents as well as equivalents developed in the future, e.g. any elements developed that perform the same function, regardless of structure.

Thus, for example, it will be appreciated by those skilled in the art that the figures herein can represent conceptual views of functional units embodying the principles of the technology, and/or various processes which may be substantially represented in computer readable medium and executed by a computer or processor, even though such computer or processor may not be explicitly shown in the figures.

The functions of the various elements including functional blocks may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and are thus machine-implemented.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

### Advantages of at Least Some of the Embodiments as Disclosed Herein

It is an advantage that network function (NF) service consumers can implement more optimized service addressing functionality, as NF cluster instance ID comprises information about how load balancing can be performed per NF service request. Upon reception of a single IP address within the NF cluster instance ID, the NF service consumer is indicated that load balancing is catered for inside the NF that is exposing the requested service.

Latency critical NF service consumers/clients can dynamically select which NF instances shall provide the requested target NF service, and which NF shall host said target NF service. In the case of latency sensitive consumers/clients and/or when load balancing is required, it is imperative that the consumer remains associated with the NF throughout a session.

It is also an advantage that NF service consumers/clients having stringent High availability (HA) requirements can decide how their HA policy shall be enforced, e.g. the NF exposing the service address may have internal HA mechanism behind the exposed address. Alternatively, the NF service consumer/client may have to enforce HA mechanism based on a NF cluster instance identity and a range of IP addresses towards a specific NF.

The present disclosure also enables NFs that are offering state critical services to offer High availability (HA) functionality if so required, as the NRF can apply a selection criterion when determining IP addresses for said requested service.

### ABBREVIATIONS

3GPP third generation partnership project

5G fifth generation (mobile communication)

5GC 5G core network

AF application function

AMF access and mobility function

AN access network

AUSF authentication server function

HA high availability

ID identity

IMS IP multimedia subsystem

IoT Internet of things

IP Internet protocol

LB load balancing

NEF network exposure function

NF network function

NRF network repository function

NSSF network slice selection function

PCF policy control function

SR session repository

SMF session management function

TS technical specification

UDM unified data management

UPF user plane function

VNF virtualized NF

1-29. (canceled)

30. A method of a fifth generation mobile communication (5G) system for providing information to a network function (NF) service consumer for supporting selection of an NF instance out of group of NF instances providing a target NF service; the method comprising:
sending, from the NF service consumer and to a network function repository function (NRF), an NRF discovery request, wherein the NRF discovery request comprises a name of the target NF service;
determining, by the NRF, an NRF discovery response in response to the NRF discovery request; wherein the NRF discovery response comprises one or more addresses for the target NF service, and one or more NF cluster instance identities; wherein each one of the one or more NF cluster instance identities relates two or more NF instances of the group of NF instances providing the target NF service to at least one of the addresses; wherein the two or more NF instances of the group of NF instances are hosted by a specific NF that is implemented as a virtualized NF (VNF); and
sending the NRF discovery response from the NRF and to the NF service consumer, for supporting the selection of an NF instance, out of the group of NF instances providing the target NF service, based on the determined NRF discovery response with the NF instance being selected being hosted by a specific NF.

31. The method of claim 30, wherein each one of the one or more NF cluster instances comprises two or more of the NF instances providing the target NF service.

32. The method of claim 30, further comprising the NF service consumer selecting the NF instance out of the group of NF instances providing the target NF service.

33. The method of claim 30, wherein each one of the one or more NF cluster instance identities has an individual address of the one or more addresses for the target NF service.

34. The method of claim 33:
further comprising the NF service consumer selecting the NF instance out of the group of NF instances providing the target NF service; and
wherein the selecting the NF instance out of the group of NF instances comprises addressing two or more of the NF instances using a single address of the one or more addresses for the target NF service.

35. The method of claim 33, further comprising performing load balancing within each NF cluster instance between the two or more NF instances providing the target NF service.

36. The method of claim 30, wherein each one of the two or more of the NF instances, within each NF cluster instance, has an individual address of the one or more addresses for the target NF service.

37. The method of claim 36:
further comprising the NF service consumer selecting the NF instance out of the group of NF instances providing the target NF service; and
wherein the selecting the NF instance out of the group of NF instances comprises addressing two or more of the NF instances using individual addresses of the one or more addresses for the target NF service, wherein the two or more NF instances are hosted by a specific NF.

38. The method of claim 36, further comprising the NF service consumer performing load balancing between the two or more of the NF instances, within each NF cluster instance.

39. The method of claim 30, further comprising sending, to the NRF and from an NF that is hosting NF instances, an NRF registration message; wherein the NRF registration message comprises information about which NF service is being provided by the NF, and information relating the NF instances and the NF service to an NF cluster instance identity.

40. The method of claim 30, wherein the NRF discovery request further comprises a specific characteristic type of a target NF type for NF services; and wherein the NRF discovery response comprises one or more addresses for NF services supported by the specific characteristic type of the target NF type.

41. A non-transitory computer readable recording medium storing a computer program product for controlling a fifth generation mobile communication (5G) system for providing information to a network function (NF) service consumer for supporting selection of an NF instance out of group of NF instances providing a target NF service; the computer program product comprising program instructions which, when run at least one processor of the 5G system, causes the 5G system to:
send, from the NF service consumer and to a network function repository function (NRF), an NRF discovery request, wherein the NRF discovery request comprises a name of the target NF service;
determine, by the NRF, an NRF discovery response in response to the NRF discovery request; wherein the NRF discovery response comprises one or more addresses for the target NF service, and one or more NF cluster instance identities; wherein each one of the one or more NF cluster instance identities relates two or more NF instances of the group of NF instances providing the target NF service to at least one of the addresses; wherein the two or more NF instances of the group of NF instances are hosted by a specific NF that is implemented as a virtualized NF (VNF); and
send the NRF discovery response from the NRF and to the NF service consumer, for supporting the selection of an NF instance, out of the group of NF instances providing the target NF service, based on the determined NRF discovery response with the NF instance being selected being hosted by a specific NF.

42. A server node configured to support a fifth generation (5G) mobile communication system for providing information to a network function (NF) service consumer for supporting selection of an NF instance out of a group of NF instances providing a target NF service; wherein the 5G system comprises the NF service consumer and a network function repository function (NRF); the server node comprising:
processing circuitry;
memory containing instructions executable by the processing circuitry whereby the server node is operative to:
send, from the NF service consumer and to the NRF, an NRF discovery request; wherein the NRF discovery request comprises a name of the target NF service;
determine, by the NRF, an NRF discovery response in response to the NRF discovery request; wherein the NRF discovery response comprises one or more addresses for the target NF service, and one or more NF cluster instance identities; wherein each one of the one or more NF cluster instance identities relates two or more NF instances of the group of NF instances providing the target NF service to at least one of the addresses; wherein the two or more NF instances, of the group of NF instances, are hosted by a specific NF that is implemented as a virtualized NF (VNF); and
send the NRF discovery response from the NRF to the NF service consumer, for supporting the selection of an NF instance, out of the group of NF instances providing the target NF service, based on the determined NRF discovery response with the NF instance being selected being hosted by a specific NF.

43. The server node of claim 42, wherein each one of the one or more NF cluster instances comprises two or more of the NF instances providing the target NF service.

44. The server node of claim 42, wherein the instructions are such that the server node is operative to cause the NF service consumer to select the NF instance out of the group of NF instances providing the target NF service.

45. The server node of claim 42, wherein each one of the one or more NF cluster instance identities has an individual address of the one or more addresses for the target NF service.

46. The server node of claim 45, wherein the instructions are such that the server node is operative to cause the NF service consumer to:
select the NF instance out of the group of NF instances providing the target NF service;
address two or more of the NF instances using a single address of the one or more addresses for the target NF service.

47. The server node of claim 45, wherein the instructions are such that the server node is operative to cause each NF cluster instance to perform load balancing between the two or more NF instances providing the target NF service.

48. The server node of claim 42, wherein each one of the two or more of the NF instances, within each NF cluster instance, has an individual address of the one or more addresses for the target NF service.

49. The server node of claim 48, wherein the instructions are such that the server node is operative to cause the NF service consumer to address two or more of the NF instances using individual addresses of the one or more addresses for the target NF service; wherein the two or more NF instances are hosted by a specific NF.
